(19) United States
(12) Patent Application Publication
(10) Pub. No.: US 2011/0017064 A1
(43) Pub. Date: Jan. 27, 2011

(54) SOOT FILTER HAVING OBLIQUE CORRUGATED LAYERS

(75) Inventor: Xiaogang Zhang, Novi, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 12/510,087

(22) Filed: Jul. 27, 2009

(51) Int. Cl. B01D 46/02; B01D 50/00; B01D 53/86

(52) U.S. Cl. 95/273; 422/180; 55/497

(57) ABSTRACT

A soot filter for removing soot from engine exhaust. The soot filter comprises an inlet, an outlet disposed opposite the inlet, a first corrugated layer having a first series of parallel ridges extending from the inlet to the outlet and aligned in a first direction, and a second corrugated layer having a second series of parallel ridges extending from the inlet to the outlet and aligned in a second direction. The second direction is oblique to the first direction, with the first series of parallel ridges being obliquely angled along an entire path from the inlet to the outlet. In this way, a variety of flow paths can be provided to increase particulate trapping.

### TECHNICAL FIELD

The present application relates to the field of emissions control in motor vehicles, and more particularly, to removing soot from motor-vehicle engine exhaust.

### BACKGROUND AND SUMMARY

An exhaust system for a motor vehicle may include a soot filter for trapping soot and other particulates from engine exhaust. The soot filter may support a regeneration phase, where soot trapped in the filter is destroyed by combustion. In this manner, the capacity of the soot filter for continued trapping may be restored as needed. When particularly configured to remove particulates from, and be regenerated by, diesel-engine exhaust, a soot filter as described herein filter may be called a ‘diesel particulate filter’ (DPF).

A soot filter may comprise a ceramic substrate or a metal substrate. The ceramic substrate may have perforated walls where trapped particulate collects; this configuration enables high trapping efficiencies, but requires periodic exposure to high-temperature exhaust flow for regeneration. Such conditions degrade fuel economy and may complicate overall emissions control, particularly with respect to nitrogen-oxide (NOX) emissions. The metal substrate, on the other hand, presents numerous, relatively long flow channels where trapped particulate collects; this configuration may enable lower trapping efficiencies, but can be regenerated at lower temperatures, even during normal operating conditions of the engine.

Soot filters of various configurations are known. In one example, U.S. Pat. No. 6,582,490 describes a pre-form for an exhaust-aftertreatment filter having numerous, parallel flow channels extending from the inlet to the outlet. In another example, U.S. Patent Application Number 2007/0128089 describes a particulate filter having layers of parallel inlet channels stacked among alternating layers of parallel outlet channels, where the inlet channels are oriented perpendicular to the outlet channels. In this example, the layers of inlet and outlet channels are separated by porous plates.

However, the inventors herein have recognized that the channel arrangements disclosed in the cited references may not provide the most effective flow geometries for improving the trapping efficiencies of metal-substrate soot filters. Therefore, one embodiment provides a soot filter for removing soot from engine exhaust. The soot filter comprises an inlet, an outlet disposed opposite the inlet, a first corrugated layer having a first series of parallel ridges extending from the inlet to the outlet and aligned in a first direction, and a second corrugated layer having a second series of parallel ridges extending from the inlet to the outlet and aligned in a second direction. In this embodiment, the second direction is oblique to the first direction, with the first series of parallel ridges being obliquely angled along an entire path from the inlet to the outlet.

### BRIEF DESCRIPTION OF THE DRAWINGS

FIG. 1 schematically shows aspects of an example system including a soot filter, in accordance with an embodiment of the present disclosure.

FIG. 2 schematically shows exterior configurations of two example soot filters in accordance with embodiments of the present disclosure.

FIG. 3 shows aspects of a box-shaped soot filter in accordance with an embodiment of the present disclosure.

FIG. 4 shows a graph representing a changing hydraulic area for exhaust gas flow as a function of distance through a box-shaped soot filter in accordance with an embodiment of the present disclosure.

FIG. 5 illustrates aspects of a pattern of exhaust flow through a box-shaped soot filter in one example scenario in accordance with an embodiment of the present disclosure.

FIG. 6 schematically shows inlets of two example soot filters in accordance with embodiments of the present disclosure.

### DETAILED DESCRIPTION

The subject matter of the present disclosure is now described by way of example and with reference to certain illustrated embodiments. Components that may be substantially the same in two or more embodiments are identified coordinately and are described with minimal repetition. It will be noted, however, that components identified coordinately in different embodiments of the present disclosure may be at least partly different. It will be further noted that the drawings included in this disclosure are schematic. Views of the illustrated embodiments are generally not drawn to scale; aspect ratios, feature size, and numbers of features may be purposely distorted to make selected features or relationships easier to see

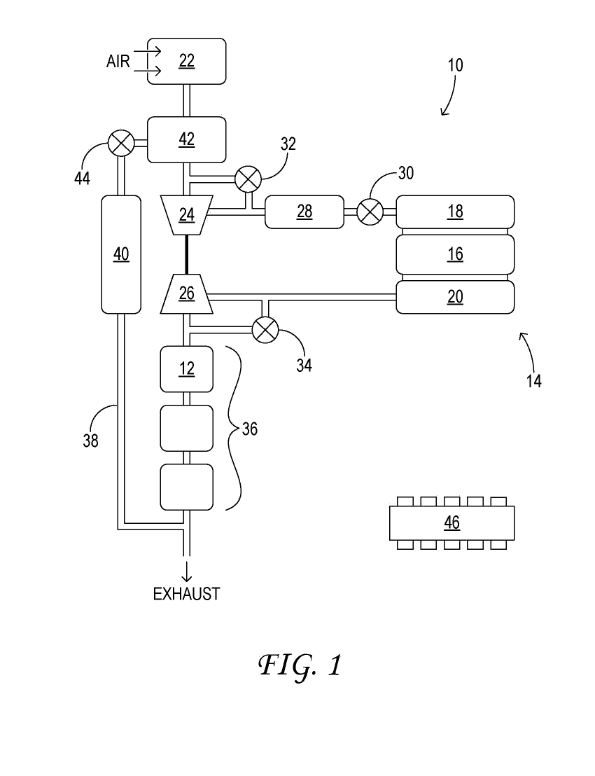

FIG. 1 shows aspects of an example system 10 comprising soot filter 12 as further described hereinafter. The system includes engine 14, in which a plurality of combustion chambers 16 are each coupled to intake manifold 18 and to exhaust manifold 20. In the combustion chambers, combustion may be initiated and sustained via spark ignition and/or compression ignition in any variant. Further, the engine may be configured to consume any of a variety of fuels: gasoline, alcohols, diesel, biodiesel, compressed natural gas, etc. The fuel may be supplied to the combustion chambers via direct injection, port injection, or any combination thereof.

System 10 is configured to supply compressed air to engine 14. Air enters the system via air cleaner 22 and flows through to compressor 24. The compressor may be virtually any type of air compressor—a supercharger compressor or electrically driven compressor, for example. In the embodiment shown in FIG. 1, the compressor is a turbocharger compressor mechanically coupled to turbine 26, the turbine driven by exhaust from exhaust manifold 20. After compression, the intake air is cooled in intercooler 28 en route to throttle valve 30. The intercooler may be any suitable heat exchanger configured to cool the intake air for desirable combustion properties. In the illustrated embodiment, by-pass valve 32 is arranged so that the intake air pressure upstream of the throttle may be reduced, as desired, by routing compressed intake air back to the turbocharger inlet.

As noted above, exhaust from exhaust manifold 20 flows to turbine 26 to drive the turbine. When reduced turbine torque is desired, some exhaust may be directed instead through waste gate 34, by-passing the turbine. The combined flow from the turbine and the waste gate then flows through a plurality of exhaust-aftertreatment devices 36, which include soot filter 12. The number, nature, and arrangement of the exhaust-aftertreatment devices varies in the different embodiments of the present disclosure. In general, the exhaust-aftertreatment devices will include at least one catalyst configured to reduce a concentration of a pollutant in the exhaust flow. In one example, a catalyst may be configured to trap nitrogen oxides (NOX) from the exhaust flow when the exhaust flow is lean and to reduce the trapped NOX when the exhaust flow is rich. In other examples, a catalyst may be configured to disproportionate NOX, or, to selectively reduce NOX with the aid of a reducing agent. In other examples, a catalyst may be configured to oxidize residual hydrocarbons and/or carbon monoxide in the exhaust flow. Different catalysts having any such functionality may be arranged in wash coats or elsewhere in the exhaust-aftertreatment devices, either separately or together.

In some embodiments, soot filter 12 may be installed at an upstream position in the plurality of exhaust-aftertreatment devices 36. The soot filter may be installed in the upstream position if it can be regenerated without periodic high-temperature discharge that could degrade downstream exhaust-system components such as the catalysts described above. In one embodiment, the soot filter may be continuously regenerated by engine exhaust, viz., regenerated under operating conditions of the engine that result in exhaust gas above a first, relatively low, minimum regeneration temperature (e.g., without post injections, etc.)—in contrast to a periodic regeneration phase where extra heat and/or uncombusted fuel is provided in the exhaust flow to raise exhaust temperature above a relatively high minimum regeneration temperature.

Continuing in FIG. 1, part of the exhaust flowing from exhaust-aftertreatment devices 36 may be released into the atmosphere via a silencer, tail pipe, etc. However, the balance of the exhaust enters EGR conduit 38 and flows to EGR cooler 40. The EGR cooler may be any suitable heat exchanger configured to cool the exhaust to temperatures suitable for mixing into the intake air.

The particular embodiment shown in FIG. 1 includes venturi device 42 configured to suction the exhaust from EGR conduit 38 and to mix the exhaust into the intake air. The amount of exhaust available for mixing is regulated by EGR valve 44. Accordingly a mixture of fresh intake air and exhaust is provided to the inlet of compressor 24, where it is compressed, and after cooling, supplied upstream of throttle valve 30.

In some embodiments, some or all of throttle valve 30, by-pass valve 32, waste gate 34, and EGR valve 44 may be electronically controlled valves configured to close and open at the command of an electronic control system. Further, one or more of these valves maybe continuously adjustable. Accordingly, FIG. 1 shows electronic control system 46, which may be any electronic control system of the vehicle in which system 10 is installed. The electronic control system may be operatively coupled to each of the electronically controlled valves and configured to command their opening, closure, and/or adjustment as needed to enact suitable control functions. To this end, the electronic control system may be operatively coupled also to various sensors arranged throughout the illustrated system-temperature sensors, pedal-position sensors, pressure sensors, etc.

It will be understood that system 10 represents one of numerous contemplated engine-system embodiments that include a soot filter as further described below. Other embodiments may differ from the illustrated system by omission of certain components-EGR components, turbocharger components, etc., and/or by inclusion of other components not shown in FIG. 1.

FIG. 2 schematically shows exterior configurations of soot filter 12 in two example embodiments. In particular, the drawing shows box-shaped soot filter 12A and cylindrical soot filter 12B. The box-shaped soot filter includes inlet 48A and outlet 50A, which may be rectangular, or may otherwise include at least one straight, peripheral edge. Likewise, the cylindrical soot filter includes inlet 48B and outlet 50B, which may have a wholly or partly rounded periphery. In both illustrated embodiments, the length of the soot filter from the inlet to the outlet is denoted FL. It will be understood that soot filters of numerous other exterior configurations are embraced by the present disclosure.

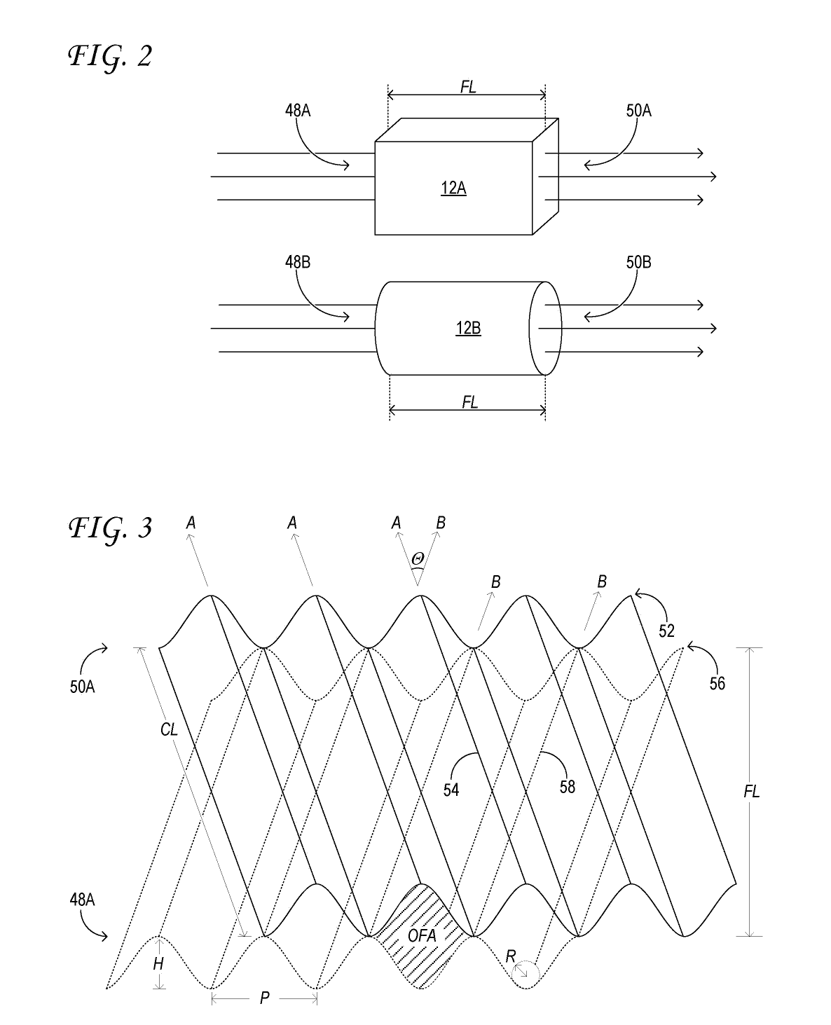

FIG. 3 shows aspects of box-shaped soot filter 12A in one example embodiment. In particular, the drawing shows a first corrugated layer 52 having a plurality of straight, parallel ridges (e.g., ridge 54) extending from inlet 48A to outlet 50A and aligned in first direction A. The drawing also shows second corrugated layer 56 having a plurality of straight, parallel ridges (e.g., ridge 58) extending from the inlet to the outlet and aligned in a second direction B oblique to first direction A. As further shown in FIG. 3, the ridges of the first corrugated layer and the ridges of the second corrugated layer are each angled obliquely along the entire path from the inlet to the outlet. Thus, the illustrated embodiment provides no flow channel along the shortest (straight) path from the inlet to the outlet. In the embodiment shown in FIG. 3, first corrugated layer 52 and second corrugated layer 56 are stackable, and accordingly, the first corrugated layer is shown stacked upon the second corrugated layer. It will be understood that the first and second corrugated layers shown in the drawing may be among a plurality of staked layers arranged in box-shaped soot filter 12A. Thus, the first corrugated layer may be among a first series of corrugated layers having ridges aligned in the first direction, and the second corrugated layer may be among a second series of corrugated layers having ridges aligned in the second direction. Accordingly, each corrugated layer of the first series may be stacked directly upon a corrugated layer of the second series. In the embodiment shown in FIG. 3, the first and second corrugated layers are stackable because the ridges of each layer are aligned against two parallel planes spaced apart by the ridge height H. Accordingly, the box-shaped soot filter may include a plurality of corrugated layers stacked upon each other such that all the ridges are aligned against mutually parallel planes. In other embodiments, however, the corrugated layers may be stackable even though the ridges are not aligned against mutually parallel planes (vide infra).

In some embodiments, the various corrugated layers of box-shaped soot filter 12A may be formed from metal sheets bent to provide the desired corrugated substrate. In other embodiments, the corrugated layers may be formed from any other suitable heat-resistant material, formed by molding, extrusion, or any other suitable process. After the desired corrugated substrate is formed, a catalytic wash coat may applied to the corrugated layers via spray coating, dip-coating, electrolysis, or any other suitable process. The catalytic wash coat may comprise an oxidation catalyst that enables oxidation of soot by engine exhaust at suitably low temperatures, including normal exhaust temperatures of a diesel engine. Accordingly, the wash coat may comprise a DPF wash coat.

For purposes of illustration, various metrics of box-shaped soot filter 12A are identified in FIG. 3. These include ridge height H, channel length CL, channel pitch P, radius of ridge curvature R, and layer offset angle Θ, which is the angle between a ray aligned in direction A and an intersecting ray aligned in direction B. In addition, the open frontal area per channel OFA is defined, as shown in FIG. 3, as the shaded area between the first and second corrugated surfaces in the plane of the inlet. In embodiments where the inlet is oriented oblique to the direction of inlet flow, OFA may be defined as the geometric projection of the shaded area between the two corrugated surfaces in a plane normal to the direction of inlet flow.

It will be understood that the drawing in FIG. 3, provided by way of example, places no particular restriction on directions A or B. Accordingly various ranges of the layer offset angle Θ are embraced by the present disclosure. In one embodiment, for example Θ may be any angle between 10 and 80 degrees. In another embodiment, Θ may be any angle between 30 and 60 degrees.

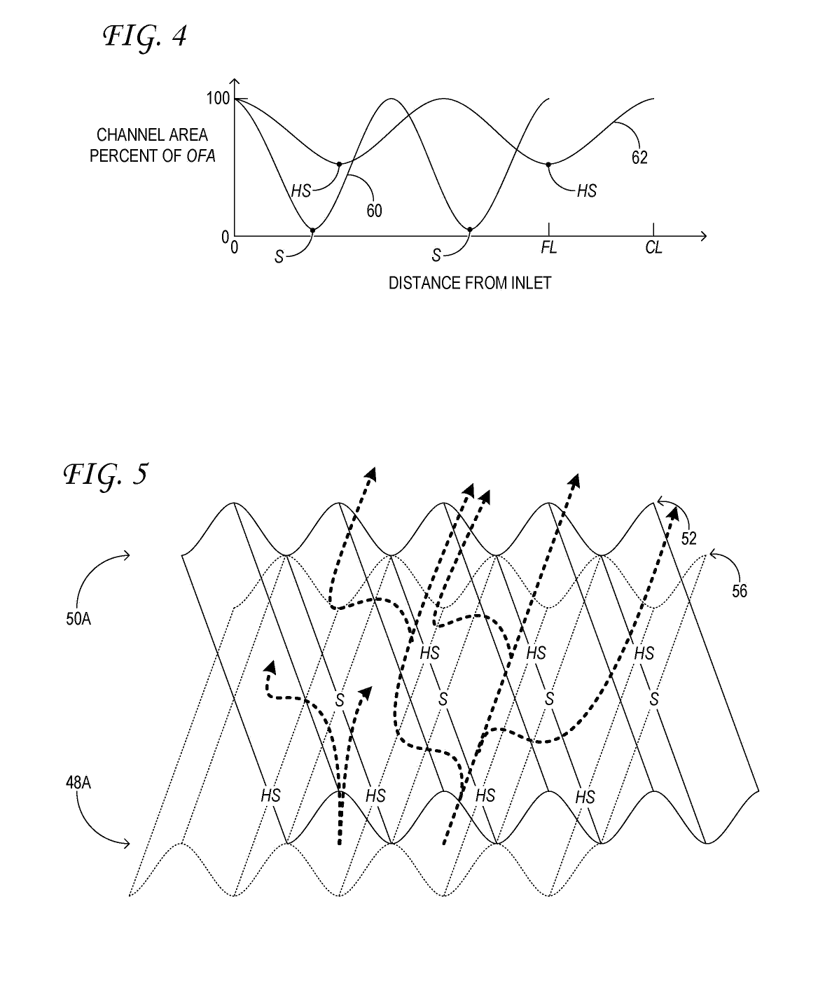

FIG. 4 shows a graph representing the changing hydraulic area for exhaust gas flow as a function of distance through box-shaped soot filter 12A. The graph includes, at 60, a plot of the hydraulic area versus distance from inlet 48A along the length direction of the box-shaped soot filter (e.g., straight through from the inlet to the outlet). For exhaust gas flow in this direction, the maximum hydraulic area is found at the inlet and follows a periodic function. As the exhaust gas flows through the filter from the inlet to the outlet, the hydraulic area is reduced and reaches zero at each of a series of stagger points labeled S. As the exhaust gas continues to the outlet, the hydraulic area then increases and reaches a maximum value at every half-way point between two adjacent stagger points.

FIG. 4 also shows, at 62, a plot of hydraulic area versus distance along any given flow channel, in direction A or B. The hydraulic area for flow in this direction is also maximum at inlet 48A and follows a periodic function, decreasing to one half the maximum value at each of a series of half-stagger points labeled HS. As the exhaust gas continues to the outlet, the hydraulic area then increases and reaches a maximum at every half-way point between two adjacent half-stagger points.

Based on the characteristics illustrated in FIG. 4, the exhaust flow rate within box-shaped soot filter 12A can never be constant, either in the length direction or in the direction of any given channel. When the exhaust gas flowing through a channel encounters a reduced hydraulic area, it tends to cross over into a channel of larger hydraulic area. This behavior gives rise to a complex flow pattern having an elongated flow path, as shown in FIG. 5. The elongated flow path, together with a longer residence time for engine exhaust passing through the filter, may give rise to more efficient particle trapping relative to soot filters that lack the inventive structure of oblique, corrugated layers, as described herein. Further, it will be evident from FIG. 4 that the number of stagger points and the number of half-stagger points experienced by the exhaust flow increases with increasing filter length FL and with increasing layer offset angle Θ. Thus, the flow path and the residence time may be adjusted by varying either or both of these parameters to suit particular engine systems and applications.

FIG. 5 illustrates aspects of a pattern of exhaust flow through box-shaped soot filter 12A in one example scenario. As exhaust gas flows through the channel inlet along a channel direction (A or B), the decreasing hydraulic area of the channel in the vicinity of a half-stagger point causes the exhaust gas to flow over the ridges of neighboring channels. Similarly, exhaust flow in the length direction of the box-shaped soot filter is forced to go around each stagger point, thereby deviating from the length direction and increasing the effective path length through the filter.

The flow characteristics represented in FIGS. 4 and 5 illustrate that as engine exhaust passed through box-shaped soot filter 12A, a first exhaust flow may pass through the soot filter in a first direction (direction A or B) while the cross-sectional area of the first exhaust flow varies periodically over a first area range (e.g., between OFA/2 and OFA). Meanwhile, a second exhaust flow may pass through the soot filter in a second direction (e.g., the length direction of the soot filter, which is oblique to the first direction), while the cross-sectional area of the second exhaust flow varies over a second range (e.g., between zero and OFA). Further, a third exhaust flow may be diverted from the first exhaust flow in a region of the soot filter where the cross-sectional area of the first exhaust flow is reduced relative to OFA. By crossing over a corrugation ridge and into a neighboring flow channel, the third exhaust flow may continue through the soot filter in the first direction. Flowing engine exhaust through the soot filter in this manner provides an advantageously longer net path through the filter and longer residence time in the soot filter, which by inference increases the efficiency of particle trapping.

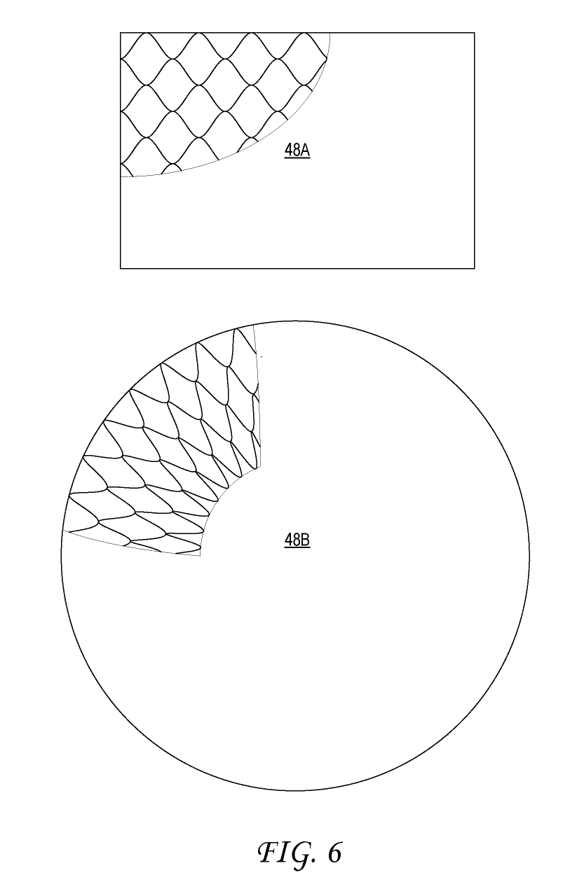

FIG. 6 schematically shows inlet 48A of box-shaped soot filter 12A and inlet 48B of cylindrical soot filter 12B. The basic arrangement of corrugated layers of the cylindrical soot filter may be substantially the same as described above in the context of the box-shaped soot filter. In addition, the factors affecting the hydraulic areas in the flow channels may be substantially as described above. However, certain differences result from the different configurations of the two illustrated embodiments. In the cylindrical soot filter, for instance, the ridges of each corrugated layer are aligned to concentric shells instead of mutually parallel planes. Accordingly, a first and second series of corrugated layers may be arranged concentrically, and each corrugated layer of the first series may be arranged directly over a corrugated layer of the second series. Further, while the channels of the box-shaped filter may all be of the same size and shape, the size and shape of the channels in the cylindrical soot filter vary with distance from the central axis. In particular, the ridge pitch P, defined hereinabove, may increases outward from the central axis so that ridges of adjacent layers may be kept in registry with each other at the inlet.

Finally, it will be understood that the articles, systems and methods described herein are exemplary in nature, and that these specific embodiments or examples are not to be considered in a limiting sense, because numerous variations are contemplated. Accordingly, the present disclosure includes all novel and non-obvious combinations and sub-combinations of the various systems and methods disclosed herein, as well as any and all equivalents thereof.

1. A soot filter for removing soot from engine exhaust, comprising:
an inlet;
an outlet disposed opposite the inlet;
a first corrugated layer having a plurality of straight, parallel ridges extending from the inlet to the outlet and aligned in a first direction; and
a second corrugated layer having a plurality of straight, parallel ridges extending from the inlet to the outlet and aligned in a second direction oblique to the first direction.

2. The soot filter of claim 1, where at least one of the inlet and the outlet has a rounded periphery.

3. The soot filter of claim 1, where at least one of the inlet and the outlet has a straight peripheral edge.

4. The soot filter of claim 1, where the second direction is oriented between 10 and 80 degrees from the first direction.

5. The soot filter of claim 1, where the second direction is oriented between 30 and 60 degrees from the first direction.

6. The soot filter of claim 1, where the first and second corrugated layers comprise a metal substrate.

7. The soot filter of claim 1, where the first and second corrugated layers comprise an oxidation catalyst.

8. The soot filter of claim 1, where the oxidation catalyst is included in a wash coat applied to the first and second corrugated layers.

9. A soot filter for removing soot from engine exhaust, comprising:
an inlet;
an outlet disposed opposite the inlet;
a first corrugated layer having a first series of parallel ridges extending from the inlet to the outlet and aligned in a first direction; and
a second corrugated layer having a second series of parallel ridges extending from the inlet to the outlet and aligned in a second direction oblique to the first direction, with the first series of parallel ridges being obliquely angled along an entire path from the inlet to the outlet.

10. The soot filter of claim 9, where the first corrugated layer is among a first series of corrugated layers having ridges aligned in the first direction, and the second corrugated layer is among a second series of corrugated layers having ridges aligned in the second direction.

11. The soot filter of claim 10, where each corrugated layer of the first series is stacked directly upon a corrugated layer of the second series.

12. The soot filter of claim 10, where the first and second series of corrugated layers are arranged concentrically, and each corrugated layer of the first series is arranged directly over a corrugated layer of the second series.

13. A system comprising:
an engine;
an exhaust system configured to receive exhaust from the engine and comprising a first catalyst for reducing a concentration of a pollutant in the exhaust; and
a soot filter coupled in the exhaust system, the soot filter comprising an inlet; an outlet disposed opposite the inlet; a first corrugated layer having a plurality of straight, parallel ridges extending from the inlet to the outlet and aligned in a first direction; and a second corrugated layer having a plurality of straight, parallel ridges extending from the inlet to the outlet and aligned in a second direction oblique to the first direction.

14. The system of claim 13, where the soot filter is arranged upstream of the first catalyst.

15. The system of claim 13, where the soot filter further comprises a second catalyst applied to the first and second corrugated layers for enabling oxidation of soot by the exhaust under normal operating conditions of the engine.

16. The system of claim 13, where the first catalyst is a nitrogen-oxide reducing catalyst.

17. The system of claim 13, where the engine is a diesel engine.

18. A method for removing soot from engine exhaust, comprising:
passing a first exhaust flow through a soot filter in a first direction while periodically varying a cross-sectional area of the first exhaust flow over a first area range; and
passing a second exhaust flow through the soot filter in a second direction, oblique to the first direction while periodically varying a cross-sectional area of the second exhaust flow over a second area range greater than the first area range.

19. The method of claim 18, further comprising diverting a third exhaust flow from the first exhaust flow in a region of the soot filter where the cross-sectional area of the first exhaust flow is reduced.

20. The method of claim 19, further comprising passing the third exhaust flow through the soot filter in the first direction.

21. The method of claim 17, further comprising collecting at least some soot in the soot filter and combusting the at least some soot during normal operating conditions of the engine.
